(19) United States
(12) Patent Application Publication
(10) Pub. No.: US 2009/0131208 A1
(43) Pub. Date: May 21, 2009

(54) Tensioner With Molded Arm

(76) Inventors: Chris D. Hawryluck, Georgetown (CA); Donavan R. Chambers, Toronto (CA); Gary J. Spicer, Mississauga (CA); Larry J. Ferriman, Campbellville (CA); Christiaan Vander Ploeg, Aurora (CA)

Correspondence Address: MAGNA INTERNATIONAL, INC., 337 MAGNA DRIVE, AURORA, ON, L4G-7K1, CA

(21) Appl. No.: 11/910,783

(22) PCT Filed: Apr. 6, 2006
(86) PCT No.: PCT/CA06/00518

§ 371 Date: Oct. 31, 2007

Related U.S. Application Data
(60) Provisional application No. 60/669,841, filed on Apr. 8, 2005.

(51) Int. Cl. F16H 7/12

(52) U.S. Cl. 474/135

(57) ABSTRACT

A tensioner for tensioning a flexible drive means is disclosed which has fewer components than comparable prior art tensioners. The tensioner is less expensive to manufacture and assemble and is easily installed. The tensioner includes a tensioner arm molded from a suitable plastic material and a pivot bushing formed from a different material, the pivot bushing preferably being over molded about the tensioner arm. The pivot bushing and tensioner arm include a series of longitudinal slots to form fingers from the tensioner arm and pivot bushing, the fingers engaging the pivot surface of the pivot shaft about which the arm pivots. A coil spring is used to bias a rotatable member on the tensioner arm into contact with the flexible drive means to be tensioned and a portion of the coil spring engages the fingers to squeeze them to increase the frictional force between the pivot bushing and the pivot surface to dampen the tensioner when the tensioner arm is moved in one direction. A unique thermal management system is also disclosed which employs thermal insulating coatings and thermal dispersant coatings to manage the temperature of the tensioner arm to enhance its expected operating lifetime.

### FIELD OF THE INVENTION

The present invention relates to tensioners for flexible drive means. More specifically, the present invention relates to tensioners for tensioning flexible drive means, such as accessory drive belts or chains, on internal combustion engines.

### BACKGROUND OF THE INVENTION

Many internal combustion engines, and most such engines for vehicles, employ one or more flexible drive means to provide engine power to operate accessories such as alternators, water pumps, air conditioning compressors, etc. Most commonly, such flexible drive means are belts which are driven directly, or indirectly, by the engine crankshaft and which transfer engine power to pulleys connected to the various accessories.

In operation, such flexible drive means are subject to torsional loads as the loads from the accessories change and from the operation of the engine itself, especially on four cylinder engines. Further, the flexible drive means can be subject to thermal expansion, as the engine generates a relatively large amount of heat, and are subject to wear.

For all of these reasons and others, such flexible drive means are typically equipped with a tensioner which operates to maintain the tension of the drive means within an intended operating range to ensure proper energy transfer to the accessories and which reduces the torsional loading on the flexible drive means to extend its operating lifetime.

Tensioners for flexible drive means are well known and typically include a rotatable member, such as a pulley (for a belt) or a gear (for a chain), which is located on a pivot arm attached to the engine and which pivot arm is biased against the flexible drive means by a spring. The movement of the pivot arm often is dampened, frictionally or otherwise, to assist in dampening changes in the torsional load on the flexible drive means.

To date, such tensioners have been fabricated from one or more metals, such as steel, aluminum and/or magnesium or other alloys and include many components which operate to inhibit off-axis movement of the arm, provide the necessary dampening, etc. Such tensioners have been relatively expensive to manufacture, both in terms of the expense of the raw materials and the expense of performing the necessary machining operations to obtain necessary bearing surfaces, etc. and such tensioners typically require many assembly steps and require special assembly machinery, further increasing the cost of manufacture.

In addition, the dampening performance of prior art metal tensioners typically varies with the operating temperature of the tensioner and varies over the lifetime of the tensioner as parts wear. Further, the pivot arms of such prior art metal tensioners have a relatively high inertia, due to the mass of the metal, which reduces the ability of the tensioner to appropriately dampen the flexible drive means. As proper dampening performance is important to correct engine operation and the operating lifetime of the flexible drive means, variations in dampening performance are undesirable.

It is desired to have a tensioner for flexible drive means which provides all necessary functionality for a tensioner and which is less expensive to manufacture and assemble, less heavy than known tensioners and which provides consistent dampening over a wide range of operating temperatures and over the lifetime of the tensioner.

### SUMMARY OF THE INVENTION

It is an object of the present invention to provide a novel tensioner for a flexible drive means which obviates or mitigates at least one disadvantage of the prior art.

According to a first aspect of the present invention, there is provided a tensioner for tensioning a flexible drive means, the tensioner comprising: a pivot shaft having a center bore to receive a mounting means to attach the tensioner to a surface and an outer pivot surface; a rotatable member having an outer surface to abut the flexible member; a pivot bushing to receive the outer pivot surface of the pivot shaft and having an inner surface complementary in shape to the outer pivot surface of the pivot shaft; a tensioner arm molded from a plastic material and receiving the pivot bushing in a bushing bore, the bushing bore and the pivot bushing including at least two longitudinal slots to form the bushing bore and pivot bushing into resilient fingers abutting the pivot shaft, the tensioner arm further including a bearing mount spaced radially from the pivot shaft; a bearing acting between the bearing mount and the rotatable member to allow the rotatable member to rotate about the bearing mount; and a coil spring having a first portion having a diameter larger than the fingers abutting the pivot shaft, the first portion being captive in the tensioner arm and having a second portion with a tang that is fixed with respect to the surface the tensioner is mounted on, the second portion having a diameter such that at least one coil of the spring contacts the fingers abutting the pivot shaft, the spring biasing the rotatable member into contact with the flexible drive means and the at least one coil squeezing the resilient fingers when the tensioner arm is pivoted in one direction about the pivot shaft to increase the frictional force between the pivot shaft and the pivot bushing to dampen movement of the tensioner arm.

Preferably, the pivot bushing is molded from a material which differs from the material of the tensioner arm and, preferably, the pivot bushing is over molded about the tensioner arm.

The present invention provides a tensioner for tensioning flexible drive means which has fewer components than comparable prior art tensioners and which is less expensive to manufacture and assemble. The tensioner includes a tensioner arm molded from a suitable plastic material and a pivot bushing formed from a different material, the pivot bushing preferably being over molded about the tensioner arm. The pivot bushing and tensioner arm include a series of longitudinal slots to form fingers from the tensioner arm and pivot bushing, the fingers engaging the pivot surface of the pivot shaft about which the arm pivots. A coil spring is used to bias a rotatable member on the tensioner arm into contact with the flexible drive means to be tensioned and a portion of the coil spring engages the fingers to squeeze them to increase the frictional force between the pivot bushing and the pivot surface to dampen the tensioner when the tensioner arm is moved in one direction. A unique thermal management system is also disclosed which employs thermal insulating coatings and thermal dispersant coatings to manage the temperature of the tensioner arm to enhance its expected operating lifetime.

### BRIEF DESCRIPTION OF THE DRAWINGS

Preferred embodiments of the present invention will now be described, by way of example only, with reference to the attached Figures, wherein:

FIG. 1 shows an exploded perspective view of a tensioner in accordance with the present invention;

FIG. 2 shows a perspective view of the top and side of an arm of the tensioner of FIG. 1;

FIG. 3 a perspective view of the bottom and side of the arm of FIG. 2;

FIG. 4 shows a perspective view of the bottom and side of the arm of FIG. 2 wherein a pivot bushing is shown exploded from the arm;

FIG. 5 shows a perspective view of the side and bottom of a pivot shaft of the tensioner of FIG. 1;

FIG. 6 shows a perspective view of the side and top of the pivot shaft of FIG. 5;

FIG. 7 shows a perspective view of the bottom and side of the assembled tensioner of FIG. 1;

FIG. 8 shows a section, taken along line 8-8 of FIG. 7;

FIG. 9 shows a perspective view of a spring of the tensioner of FIG. 1;

FIG. 10 shows an optional mounting bracket which can be employed to mount the tensioner of FIG. 1;

FIG. 11 shows a top perspective view of an arm and pivot shaft in accordance with the present invention including a thermal management system; and

FIG. 12 shows a bottom perspective view of the arm and pivot shaft of FIG. 12 including the thermal management system.

### DETAILED DESCRIPTION OF THE INVENTION

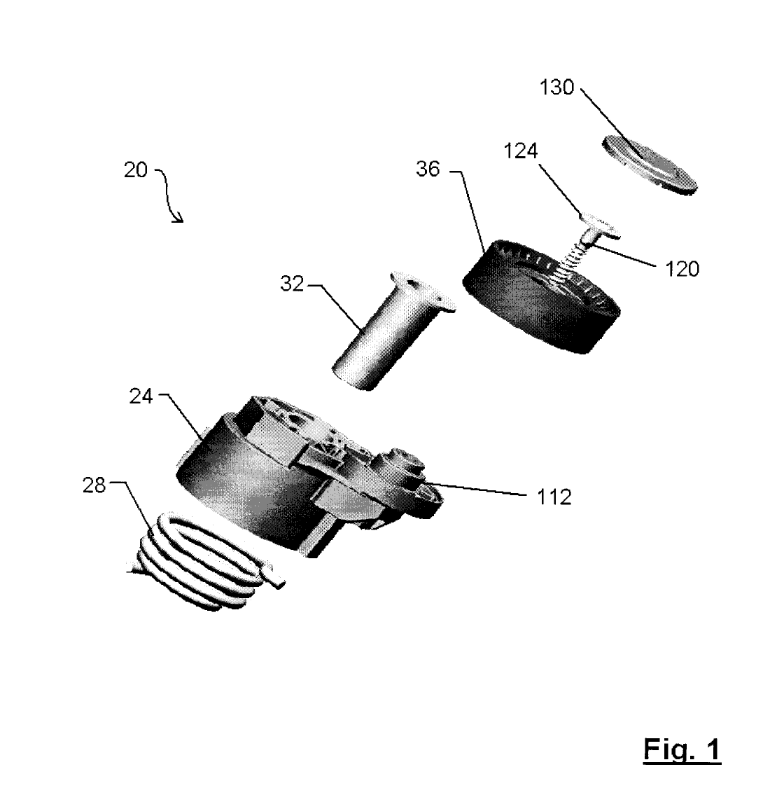

A tensioner in accordance with the present invention is indicated generally at 20 in FIG. 1. Tensioner 20 comprises an arm 24, which receives a coil spring 28 and a pivot shaft 32 and which receives a rotatable member to engage the endless flexible drive means (not shown). In the illustrated embodiment, the flexible drive means is intended to be a smooth belt and thus the rotatable member is a pulley 36. As will be apparent to those of skill in the art, if the flexible drive means is intended to be a chain, the rotatable member can be in the form of a gear, or if the flexible drive means is intended to be a toothed belt, the rotatable member can be in the form of a toothed pulley, etc.

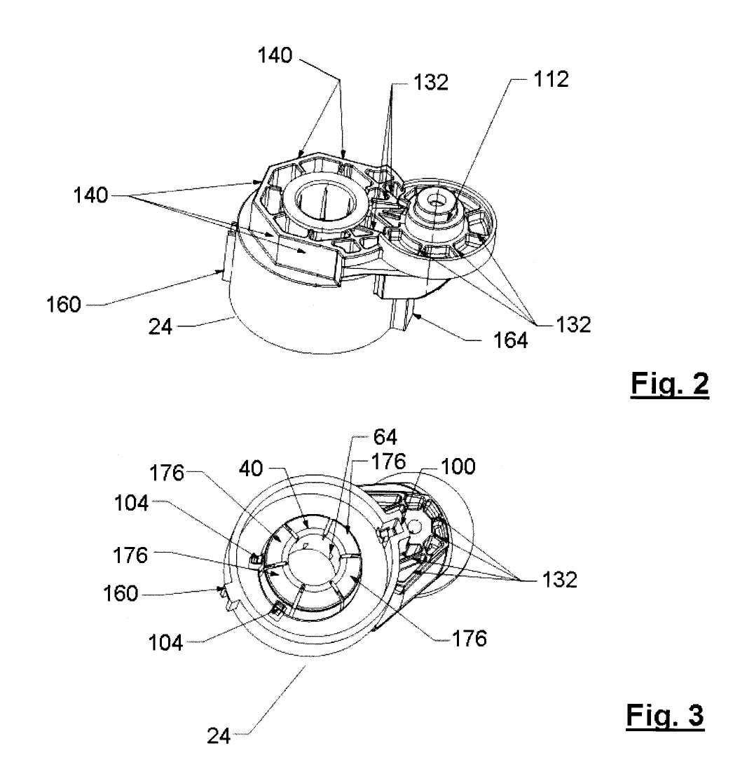

Arm 24 is shown in more detail in FIGS. 2, 3 and 4. Unlike prior art tensioners, wherein the tensioner arms were formed of metal, tensioner arm 24 is formed of molded plastic. The plastic or organic resin material used to mold arm 24 can be any suitable engineering plastic. The plastic from which arm 24 is molded is preferably selected for strength, resistance to creep and longevity.

As is understood by those of skill in the art, engineering plastic includes Polyetheretherketone resin (PEEK), Polyamideimide resin (PAI), Polysulfone resin, Polyetherimide resins (PEI), Polyimide resins, Poly(phenylene sulfide) resins, Polyester resins, such as polyethylene terephthalate, Bisphenol-A polycarbonate resins, Polyester Carbonate Copolymers, Acetal resins, and Polyamide or Nylon resins. Additionally other materials could be employed, including engineering resin blends or engineering resin alloys, which are mixtures of engineering resins or mixtures of engineering resins with commodity resins, namely Poly(phenylene ether)-styrene resin alloys. Examples of engineering resin with engineering resins include: poly(butylene terephthalate)-poly(ethylene terephthalate), polycarbonate-poly(butylene terephthalate), polycarbonate-poly(ethylene terephthalate), polycarbonate-polyester carbonate, polysulfone-poly(ethylene terephthalate), polyarylate-nylon, and poly(phenylene oxide)-nylon. Examples of engineering resins with other resins include: polysulfone-ABS, modified acetal, modified nylon, modified poly(butylene terephthalate), polycarbonate-ABS, polycarbonate-styrene maleic anhydride, and poly(phenylene oxide)-polystyrene.

In a present embodiment of the invention, arm 24 is molded from sixty percent glass fiber reinforced polyamid plastic. Examples of other suitable plastics include semi-crystalline plastics such as Nylon 6, Nylon 66, Nylon 4/6, polyphtalamide (such as Amodel), polyamid and polyimid compounds (such as Torlon), polyphenylene sulfide (such as SUPECW33) or polyethelene terephtalate (such as Rynite 550 NC010).

Also, materials other than glass, such as aramid fibres or nanoparticles, can be employed to reinforce the selected plastic.

As will be apparent to those of skill in the art, in addition to reinforcing the plastic, glass fiber reinforcement, distributed substantially uniformly in the arm substrate, will also serve to conduct heat away from pivot bushing 40 to the surface extremities of this substrate of arm 24, thereby mitigating the potential for undesired heat buildup in arm 24.

To allow arm 24 to pivot, in operation, about pivot shaft 32, a pivot bushing 40 is included in arm 24. Pivot bushing 40 is fabricated from a material which provides a suitable pivot surface, with desired wear resistance characteristics and, in a present embodiment pivot bushing 40 is molded from Nylon 4/6 with PTFE (such as Stanyl TW371), although it is contemplated that a wide variety of other suitable plastics or other suitable organic resin materials can also be employed.

While it is presently preferred that pivot bushing 40 be molded to reduce manufacturing costs, it is also contemplated that pivot bushing 40 can be formed by machining from a plastic blank or from a combination of molding and machining.

While pivot bushing 40 can be mounted to arm 24 in any suitable manner, it is presently preferred that pivot bushing 40 be over molded about arm 24, as this results in an relatively inexpensive method of mounting pivot bushing 40 and provides a good structural connection between pivot bushing 40 and arm 24. When pivot bushing 40 is over molded about arm 24, it is preferred that the outer periphery of pivot bushing 40 include outwardly extending ribs 44, or other features, to ensure a strong mechanical connection and interlock between pivot bushing 40 and arm 24. Not only do these interlocking features secure pivot bushing 40 to arm 24, but when they extend the length of pivot bore 64, described below, serving as an inhibitor to mould shrinkage.

Similarly, these interlocking features facilitate the use of transfer molding for the molding process of arm 24 and pivot bushing 40. As will be apparent, if arm 24 is transferred to another injection machine in order to over mold pivot bushing 40, molded arm 24 will experience a drop in temperature, and hence the molecular bonding (facilitated by high temperature) between arm 24 and over molded pivot bushing 40 will not be as strong as when a two-shot molding process is performed. In the case of transfer molding, the interlocking features increase the bond between pivot bushing 40 and arm 24, thus making this a more viable molding method which is less sensitive to part temperature, cycle time, etc.

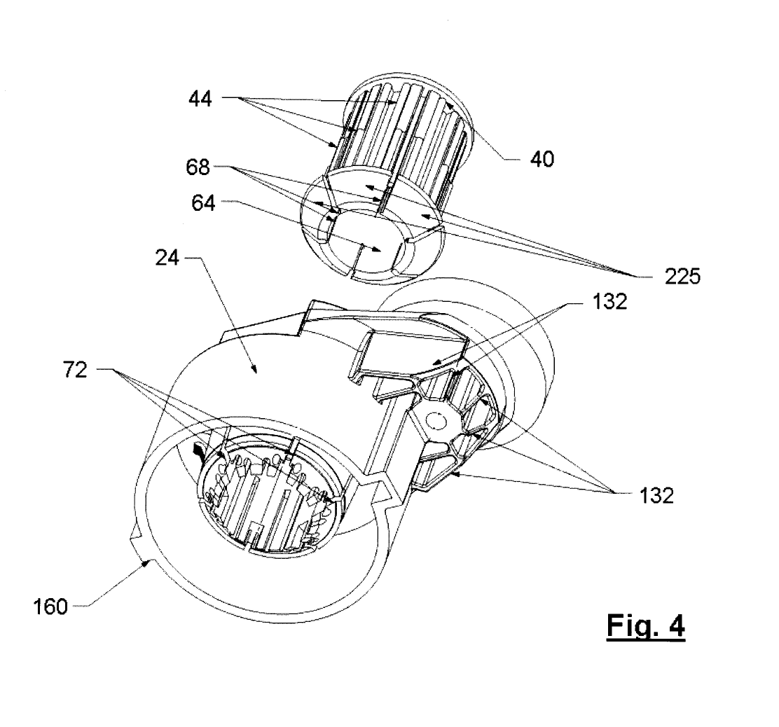

While FIG. 4 shows an exploded view of arm 24 and pivot bushing 40 for clarity, it should be apparent to those of skill in the art that pivot bushing 40 cannot be separated as shown from arm 24 when arm 24 is over molded onto pivot bushing 40. The present invention is not limited to pivot bushing 40 being over molded about arm 24 and a variety of other constructions, as will be apparent to those of skill in the art, can be employed, including over molding of arm 24 about pivot bushing 40, mechanical insertion and bonding of a separately formed pivot bushing 40 to arm 24, etc.

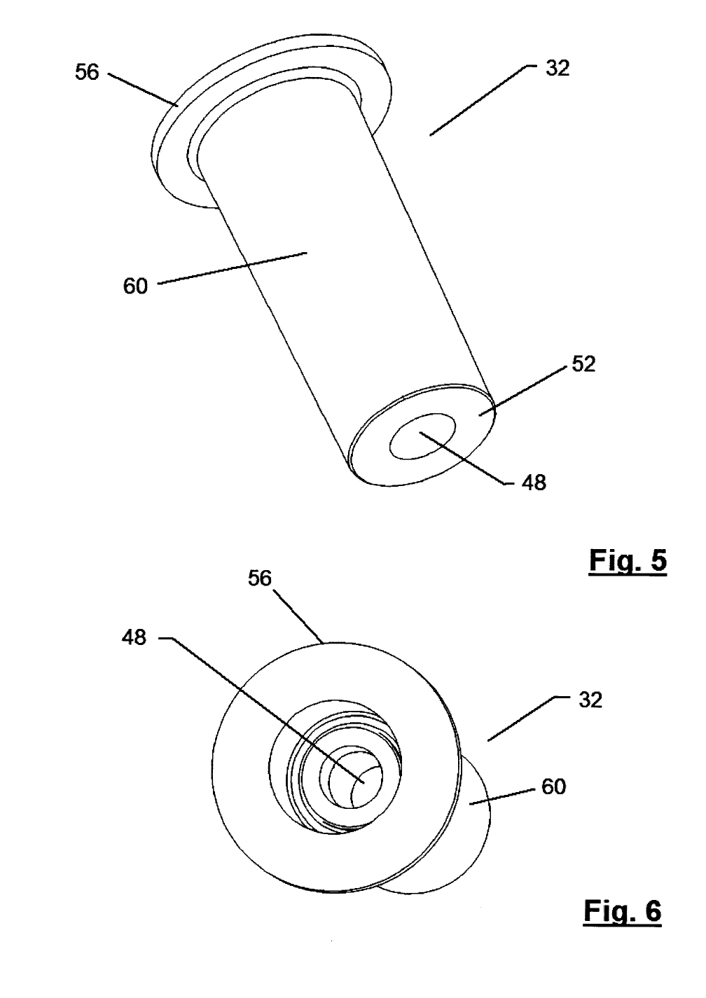

Pivot shaft 32, best seen in FIGS. 5 and 6, has a generally cylindrical inner bore 48 to receive a mounting bolt or stud to attach tensioner 20 to an engine or engine component, a flat lower face 52 to abut the engine or engine component when mounted and an upper thrust flange 56 to abut arm 24 when tensioner 20 is assembled. The outer pivot surface 56 of pivot shaft 32 is tapered from the portion adjacent thrust flange 56 to the portion adjacent lower face 52.

Pivot bushing 40 includes a pivot bore 64 which is sized to receive pivot shaft 32 and which has a complementary taper to the taper of pivot surface 60.

Pivot shaft 32 is preferably formed of an aluminum alloy, such as SAE J452, UNS A03800, by die casting and pivot surface 60 can be formed by such a die casting operation without requiring any additional machining, thus reducing the cost of tensioner 20. Although no machining operations are required, the present inventors contemplate that the performance of the pivot joint can be improved by vibratory finishing pivot surface 60 to facilitate dry lubricant transfer from pivot bushing 40 onto the pivot surface 60.

However, the present invention is not limited to pivot shaft being die cast, or formed from aluminum, and other materials such as, without limitation, stainless steel, sintered metal and/or ceramic compositions and other plastics can be employed, if desired, and other manufacturing processes, such as machining, injection and/or compression molding, etc. can be employed to create pivot shaft 32.

One of the important functions of tensioner 20 is to maintain the outer surface of pulley 36, which abuts the flexible drive means, perpendicular to the surface of the flexible drive means to prevent undue wear of the flexible drive means and/or dismounting of the flexible drive means. Therefore, it is desired that arm 24 pivots about the longitudinal axis of pivot shaft 32 substantially without off-axis deflection. Accordingly, the complementary tapered surfaces of pivot surface 60 and pivot bore 64 allow arm 24 to pivot about pivot shaft 32 while inhibiting off-axis movement of arm 24 and thus the outer surface of pulley 36 is maintained substantially perpendicular to the flexible drive means.

To accommodate wear of pivot bushing 40 and/or pivot surface 60, pivot bushing 40 includes a series of longitudinal slots 68 (best seen in FIG. 4) spaced about pivot bore 64. Arm 24 includes a corresponding set of slots 72 which align with slots 68, when arm 24 is over molded, such that the resulting structure of pivot bore 64 and the over molded portions of arm 24 form a set of fingers 76, best seen in FIG. 3. As will be apparent, the slots (68, 72) between fingers 76 allow wear materials to be directed away from pivot surface 60 and pivot bore 64, but they also provide for wear compensation and dampening, in cooperation with spring 28, as described below. It is also contemplated that pivot bushing 40 can also be fabricated with grooves, through-holes or other features to assist in the removal of wear or other materials from between pivot bore 64 and pivot surface 60.

In order to allow thermal expansion of pivot shaft 32, pivot bushing 40 preferably has a 190° circumferential relief consisting of a section of pivot bore 64 having a larger radius. The center of this arclength (the relief extending 85° on either side of this center) is located substantially opposite the line of contact of the belt hubload vector with pivot bore 64. The relief ends a few millimeters above the start of flexible fingers 76 in order to ensure that fingers 76 provide their resilient engagement of pivot shaft 32.

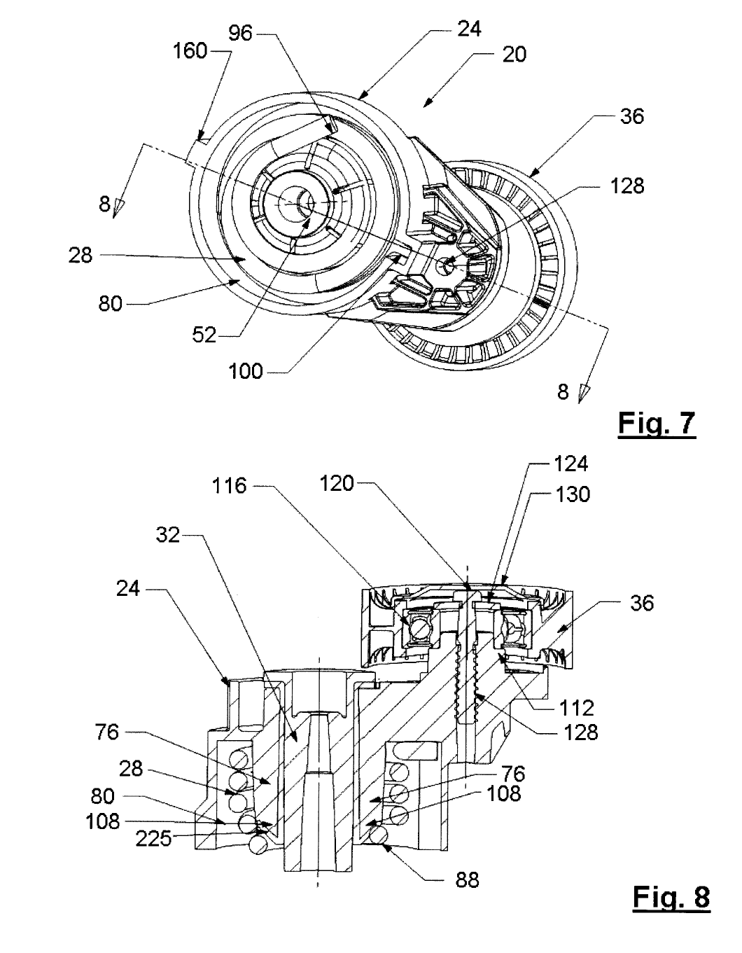

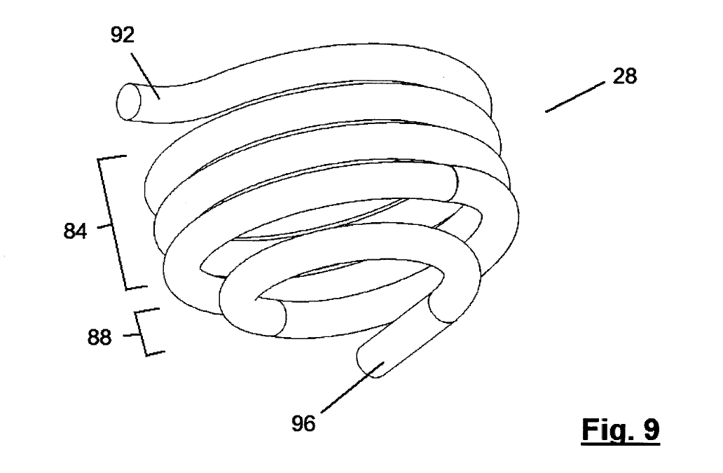

Arm 24 further includes a cylindrical volume 80 about fingers 76 in which spring 28 is received, as best seen in FIGS. 3, 7 and 8. Spring 28, as best seen in FIG. 9, is a coil spring which includes an upper portion 84, wherein the coils of spring 28 have a constant radius, and a lower portion 88 wherein the radius of at least one coil is reduced in comparison to the radius of upper portion 84. Spring 28 further includes an upper tang 92 and a lower tang 96.

Referring again now to FIGS. 3, 7 and 8, when spring 28 is assembled in tensioner 20, upper tang 92 is received and retained in a slot 100 formed in arm 24 for that purpose and, preferably, a set of retention clips 104 snap onto the upper coil of spring 28 to retain spring 28 in place prior to tensioner 20 being installed on an engine or engine component. Lower tang 96 of spring 28 extends from the bottom of tensioner 20 to engage a slot or other suitable retaining structure on the engine or engine component to which tensioner 20 is to be mounted. If concern exists regarding the generation of low frequency noise by movement of coil spring 28 against arm 24, an overlay 225 of dry lubricated Nylon or other suitable material can be positioned between coil spring 28 and arm 24.

As will now be apparent, when tensioner 20 is appropriately mounted to an engine or engine component by a mounting bolt or stud extending through bore 48 of pivot shaft 32, spring 28 is compressed axially to bias arm 24 towards flange 56. As pivot bushing 40 and/or pivot surface 60 experience normal wear, fingers 76 of arm 24 are biased up the complementary taper of pivot surface 60 of pivot shaft 32 and this acts to provide the above-mentioned wear compensation feature of tensioner 20.

Further, the lower portion 108 of fingers 76 are inclined, at an angle of approximately forty five degrees and the coils of lower portion 88 of spring 28 abut lower portion 108 when tensioner 20 is correctly installed as shown in FIG. 8. As arm 24 is pivoted away from the flexible drive means, the coils of lower portion 88 of spring 28 are wound tighter, reducing their radius, and thus squeezing fingers 76 to increase the frictional forces developed between pivot surface 60 and pivot bore 64 and dampening the movement of arm 24. Even when arm 24 is not pivoted away from the flexible drive means, fingers 76 are urged toward pivot surface 56 by lower portion 88 of spring 28 and thus pivot bushing 40 is maintained in contact with pivot surface 60, which inhibits undesirable off-axis movement of arm 24 and which inhibits uneven wear of pivot bushing 40. The level of tensioner dampening can also be adjusted, for differing applications, by altering the lengths of fingers 76 by changing the length of slots 72 and slots 68.

Arm 24 further includes a bearing mount 112 which is axially offset from the center of pivot bushing 40, to provide the eccentricity required for operation of tensioner 20, and pulley 36 is mounted to arm 24 at bearing mount 112. Specifically, pulley 36 includes a bearing 116, such as a roller bearing or the like, which can be integrally formed with pulley 36, or provided separately. As mentioned above, plastic materials are generally subject to some creep over time, especially when exposed to elevated temperatures. Accordingly, in a present embodiment of tensioner 20, bearing mount 112 is fabricated with a negative bias, with respect to the hub load force vector, such that if, or when, creep occurs in arm 24 over time, pulley 36 moves towards a zero bias position with respect to the flexible drive means, rather than to a less desired positive bias position.

A mounting bolt 120, which is preferably of a type which is thread cutting (rather than thread forming which can result in internal stress of the receiving portion of arm 24) for the plastic material of which arm 24 is fabricated, and a suitable washer, such as a Belleville washer 124, is inserted into a center bore 128, provided in bearing mount 112, to mount pulley 36 to arm 24. Alternatively, suitable screw fasteners which do not require an additional elastic member (i.e. —the Belleville washer) can also be employed and examples of such screw fasteners include the BOSSSCREW anti-shake fastener. To protect bearing 116 from dirt and/or other foreign materials, a dust cap 130 is preferably mounted over the head of bolt 120.

By employing a self-tapping mounting bolt 120, the cost which would otherwise be associated with a manufacturing step of threading bore 128 can be avoided. Similarly, as bearing mount 112 is molded with arm 24, the cost of finish machining the mount, as is typically required for cast metal arms, is avoided thus reducing the cost of manufacture of tensioner 20.

It is further contemplated that, if desired, a metal insert (not shown) can be provided in tensioner arm 24 to receive bearing 116. In one form, the metal insert can include a suitable mount surface to receive bearing 116 and can include a threaded bore to receive mounting bolt 120, which in this embodiment would not be plastic. In another form, the insert can be in the form of a stud on which bearing 116 can be fastened by a suitable nut.

While the embodiment of the present invention illustrated in the Figures is a pulley-over-center design, it will be appreciated by those of skill in the art that the present invention is not so limited and can be employed for pulley-in-line and/or pulley-below-center configurations, if desired, with appropriate and now apparent modifications. For example, for a pulley in line, the point of maximum spring contact should be 180° opposite the point of contact for a pulley-over-center tensioner. The point of maximum contact from the bottom coil of the spring on the 45° taper of the arm pivot hub provides a righting moment which, when correctly placed counters the tilting effect of the belt hubload force on the arm.

As arm 24 can be subject to a relatively significant torsional and/or bending force between pivot shaft 32 and bearing mount 112, arm 24 is preferably molded with stiffening features 132, in the form of a series of ribs and webs. The design, arrangement and placement of stiffening features 132 is not particularly limited and is within the normal expected skills of those skilled in the art and can be achieved by empirical testing or by finite element analysis or another suitable manner.

In addition to stiffening features 132, arm 24 further preferably includes an installation structure 136 which is molded with arm 24 to provide at least a pair of diametrically opposed flat surfaces 140 to which a conventional wrench or other tool can be connected to arm 24 to apply a torque thereto when tensioner 20 is installed, as described below. In fact, it is presently believed that the provision of such an installation structure provides a significant advantage and is not limited to use with tensioner 20, nor with tensioner arms that have been fabricated from plastic or the like. It is contemplated that such an installation structure can be advantageously provided on otherwise conventional tensioners.

Another problem with conventional tensioners that employ friction as a dampening force is that static electricity can be generated as a by product of the dampening and can build up within the tensioner to the point where arcing occurs to discharge the build up. Static charges and arcing can also result from movement of the flexible drive means over plastic, or other no-conductive pulleys, etc. Such arcing can damage surfaces, such as the pivot surfaces, bearing balls and races of prior art tensioners leading to premature failure of the tensioners, generate electrical and radio and/or other noise and can be a fire hazard.

Semiconductor electronics are now extensively used in automotive vehicles and electrostatic discharge and/or electrostatic interference can damage these electronics and/or interfere with their correct operation. Accordingly, the present inventors have determined that the static charges which can accumulate during normal use of tensioners can pose a problem for such automotive electronics and, in at least some embodiments of the present invention, the build up of these static charges are obviated or mitigated.

In tensioner 20, tensioner arm 24 can be molded from organic resin materials and/or compounds which resist such static build ups, for example by being sufficiently conductive to bleed off static electrical charges. Examples of such compounds include, without limitation, carbon black, carbon fibers, stainless steel fibers, aluminum flakes, nano carbon (such as “Bucky tubes”, etc.) and a variety of other materials. Further, new classes of plastic polymer materials are being developed, such as Inherently Conductive Polymers (ICPs) or Inherently Dissipative Polymers (IDPs), which can conduct current or charges along their polymer chains and arm 24 and/or other components of tensioner 20 can be fabricated from such materials.

Alternatively, tensioner arm 24 can have a coating, or regions of coating, applied to it to provide the desired conductivity to harmlessly bleed off/dissipate static charges.

By fabricating tensioner arm 24 from moldable plastic materials, various electronic and/or mechanical components can be integrally formed with arm 24. For example, it is contemplated that tensioner 20 can include one or more sensors (not shown), as described in published German Application DE 10 2005 008 580 A1, which is assigned to the assignee of the present invention and the contents of these applications are incorporated herein by reference. In such a case, tensioner arm 24 can have sensor elements such as magnets, or metal inserts, formed within or mounted on it and such sensor elements can interact with appropriate sensors, such as the model 2SA-10 Sentron sensor manufactured by Sentron AG, Baarerstrasse 73, 6300 Zug, Switzerland or any other suitable sensor which is mounted in a fixed position with respect to the engine to which tensioner 20 is mounted or on the outer end of pivot shaft 32 to provide signals indicating the position of tensioner arm 24. Alternatively, tensioner arm 24 can have one or more sensors formed within or mounted on it and such sensors can interact with magnets or metal elements on the engine to which tensioner 20 is mounted to provide signals indicating the position tensioner arm 24.

Such position signals can be provided to an engine control system as one input used to monitor and control the operation of the engine. Further, such sensor signals can be used to provide an engine controller or other system with an indication that tensioner arm 24 has traveled past its expected maximum operating position, indicating that the flexible drive means or tensioner 20 has reached the end of its operating lifetime. Alternatively, it is contemplated that one of more strain gauges (or strain gauge structures) can be molded into tensioner arm 24 to provide signals to an engine control system or the like to indicate the loading on tensioner arm 24 and/or other useful information.

It is also contemplated that arm 24 can be formed with a magnetic coil, or other electrical or electro-mechanical structure, about pivot bushing 40 to allow for varying the dampening force at pivot bushing 40. A variety of other mechanisms or devices can be included in tensioner arm 24 as will be apparent to those of skill in the art.

Assembly of tensioner 20 is believed to be simple and cost effective compared to prior art tensioners. Specifically, as shown in FIG. 1, a present embodiment of tensioner 20 comprises seven components, namely: spring 28; arm 24; pivot shaft 32; a rotatable member, such as pulley 36 (with either an integral bearing or a separate bearing); a self tapping bolt 120; a Belleville washer 124 or the like; and a dust cap 130. This is in contrast to conventional tensioners which can include twelve or more components, including additional components such as noose rings, thrust washers, spring supports, etc.

To assemble tensioner 20, spring 28 is pressed into arm 24 and is preferably retained therein by retention clips 104. Next, pivot shaft 32 is inserted into arm 24 and then pulley 36 is mounted to bearing mount 112 with mounting bolt 120 and Belleville washer 124. In the illustrated embodiment, pulley 36 overlaps flange 56 of pivot shaft 32 such that pivot shaft 32 is retained in arm 24 prior to installation of tensioner 20 and this is the preferred configuration as it reduces the number of components required for tensioner 20 and allows for simplified assembly and/or installation of tensioner 20. However, as should be apparent to those of skill in the art, the overlap of pulley 36 and flange 56 is not required by the present invention.

In contrast to the assembly described above, conventional tensioners include many more steps for assembly and typically require specialized tooling/assembly devices to tension their springs during assembly, etc. Accordingly, it is believed that the cost of assembling tensioner 20 will be significantly less than conventional tensioners.

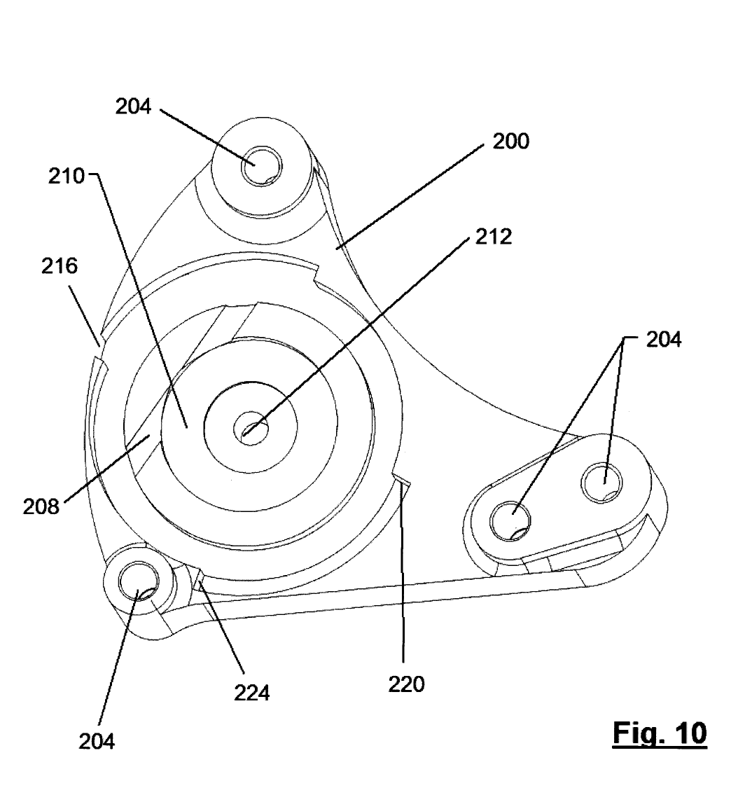

Installation of tensioner 20 is also believed to be advantageous in comparison to conventional tensioners. Tensioner 20 can be installed directly on an engine, if the engine surface includes the necessary features for tensioner 20 to engage, or tensioner 20 can be mounted to a bracket with the necessary features and the bracket can be mounted to the engine. One embodiment of a suitable bracket 200 is shown in FIG. 10.

Bracket 200 includes suitable means for mounting bracket 200 to an engine or other structure. In the illustrated embodiment, bracket 200 includes bores 204 which are used to bolt bracket 200 to the engine. Bracket 200 further includes a slot 208 to receive and keep captive lower tang 96 of spring 28 and a groove 210 against which the bottom coil of spring 28 can abut, groove 210 being wide enough to permit radial expansion and contraction of lower portion 88 of spring 28 to alter the dampening of tensioner 20, as described above.

Bracket 200 further includes a mounting bore 212 which is aligned with center bore 48 of pivot shaft 32 when tensioner 20 is properly positioned with respect to bracket 200. A mounting bolt can extend through center bore 48 and mounting bore 212 to fasten tensioner 20 to bracket 200. Alternatively, bracket 200 can be equipped with a stud instead of mounting bore 212 and center bore 48 of pivot shaft 32 can receive the stud and a nut to fasten tensioner 20 to bracket 200.

To assist in positioning lower tang 96 in slot 208, indicia are provided on bracket 200 and arm 24 to indicate the respective positions of slot 208 and tang 96. Specifically indicia 216, which can be a slot, tang, boss or any other suitable indicia structure as will be apparent to those of skill in the art, is provided on bracket 200 and indicia 160, which also can be any suitable indicia, is provided on arm 24. Indicia 216 and 160 are arranged such that when they are aligned by the installer, lower tang 96 is correctly positioned to engage slot 208. Bracket 200 can optionally provide limit stops 220 and 224 against which boss 168 on arm 24 can abut to limit the range of pivotal movement of arm 24 about pivot shaft 32 during installation of tensioner 20 and thereafter.

If tensioner 20 is to be installed directly to an engine, or other engine component, without bracket 200, then the engine or engine component should have features equivalent to slot 208 and groove 210 and preferably, will also include features equivalent to indicia 216 and limit stops 220 and 224.

To install tensioner 20, the mounting bolt or stud is inserted through center bore of pivot shaft 32, tensioner 20 is rotated to have lower tang 96 engage slot 208, or its equivalent, and the mounting bolt, or stud and nut, are tightened to axially compress spring 28 and to interface lower face 52 of pivot shaft 32 against the engine, or engine component. Next, the installer can apply a tool to installation structure 136 to rotate arm 24 to move pulley 36 away from the flexible drive means to be routed about the engine components and/or accessories. Once the flexible drive means is properly routed, the installer can allow arm 24 to rotate back to a position wherein pulley 36 abuts the flexible drive means to tension it and the installer can then remove the tool from installation structure 136 and installation is complete.

Most engineering plastics, such as those that arm 24 is preferably molded from, are subject to creep and/or fatigue over time. As is well known, one predominate factor relating to the amount of fatigue and/or creep a plastic can experience over time is the temperature the plastic is exposed to, with higher temperatures increasing the creep and/or fatigue of the plastic. As tensioner 20 is typically mounted on an engine operating at relatively high temperature or on an engine component exposed to the heat of the engine, this can be an important consideration in the design or tensioner 20. Further, the heat generated from frictional dampening of the pivoting of arm 24 about pivot shaft 32 can further exacerbate the problems of fatigue and creep.

The present inventors have developed a thermal management system for tensioner 20 and other tensioners, whether formed of plastics or metals, which can effectively manage and/or reduce undesired heating of components of a tensioner. For plastic tensioners, such as tensioner 20, the thermal management system can increase the expected lifetime of the plastic components such as arm 24 and/or reduce the amount of material (wall thickness, webs, ribs, etc.) used to form plastic components as the components experience reduced amount of creep and/or fatigue relative to like components without the thermal management system.

Specifically, the present inventors have determined that a thermal insulating coating can be applied to tensioner 20 to reduce the transfer of heat to tensioner 20 from the engine, or engine component, which tensioner 20 is mounted to. Accordingly, if a mounting bracket such as bracket 200 is employed the upper, lower, or both surfaces of the bracket can have a thermal insulating coating applied to them to inhibit heat transfer from the engine through the bracket and to tensioner 20. If tensioner 20 is to be mounted directly to an engine or engine component, the thermal insulating coating can be applied either to the engine or engine component at the location tensioner 20 is to be mounted, or can be applied to at least the lower portion 88 of spring 28, lower face 52 of pivot shaft 32 and the lower edges of arm 24 that will be located adjacent to the source of heat (i.e. —the engine and/or engine component). In tests of tensioner 20, the use of an appropriate thermal insulating coating has been shown to reduce the temperature at pivot shaft 32 by a minimum of 10° C. at engine operating temperature. Additional reductions to the pivot temperature occur when an airflow exists across the engine compartment.

Similarly, as the bearing in the rotatable member, such as bearing 116 in pulley 36, can generate significant amounts of heat in normal operation, the surfaces of bearing mount 112 which contact bearing 116 can also have a thermal insulating coating applied to inhibit transfer of this heat to arm 24. While any appropriate thermal insulating coating can be employed, in a present embodiment of the invention a thermal barrier coating sold by Tech Line Coatings, Inc. of Murrieta Calif. under the brand name TLLB is used.

While the use of an appropriate thermal insulating coating reduces the amount of heat transferred to arm 24, the second part of the above-mentioned thermal management system comprises the use of thermal dispersant coatings, which enhance the transfer of heat from the coated object to lower temperature surroundings, on plastic components such as arm 24. Accordingly, the outer surface of arm 24 can be coated with such a thermal dispersant coating to assist arm 24 in transferring heat from itself to the air surrounding it. Again, while any suitable thermal dispersant coating can be used, in a present embodiment of the invention a thermal dispersant coating sold by Tech Line Coatings, Inc. of Murrieta Calif. under the brand name TLTD is used.

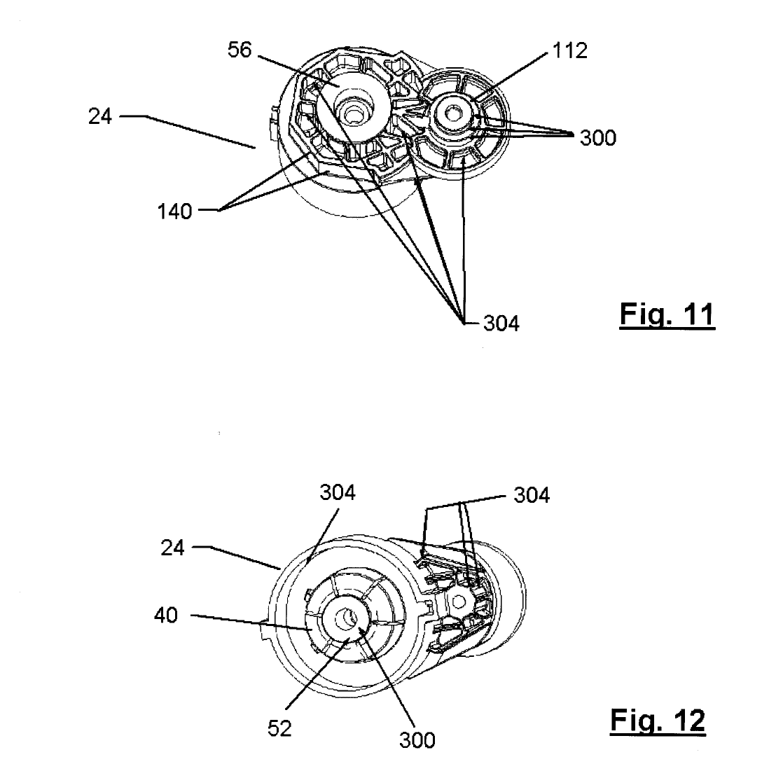

FIGS. 11 and 12 show an example of the application of the thermal management system to the assembly of arm 24, pivot bushing 40 and pivot shaft 32. In the illustrated embodiment, the TLLB thermal barrier coating 300 has been applied to bearing mount 112 and to lower face 52 of pivot shaft 32 and the TLTD thermal dispersant coating 304 has been applied to the inside surface of the cavity in arm 24 receiving coil spring 28 and to stiffening features 132.

While the disclosed thermal management system is believed to be particularly advantageous when used with tensioners with plastic tensioner arms, it is also believed to be of use with conventional tensioners to provide similar reduction and/or control of heat reaching the bearings in the rotatable member and/or pivot surfaces. The particular thermal dispersant and thermal insulating coatings referred to above can also be applied to the relevant tensioner components when they are fabricated from aluminum or other metals and the use of the disclosed thermal management system for such tensioners is contemplated by the inventors.

The present invention provides a tensioner for tensioning flexible drive means which has fewer components than comparable prior art tensioners and which is less expensive to manufacture and assemble. The tensioner includes a tensioner arm molded from a suitable plastic material and a pivot bushing formed from a different material, the pivot bushing being over molded about the tensioner arm. The pivot bushing and tensioner arm preferably include a series of longitudinal slots to form fingers from the over molded portion of the tensioner arm and pivot bushing, the fingers engaging the pivot surface of the pivot shaft about which the arm pivots. A coil spring is used to bias a rotatable member on the tensioner arm into contact with the flexible drive means to be tensioned and a portion of the coil spring engages the fingers to squeeze them to increase the frictional force between the pivot bushing and the pivot surface to dampen the tensioner when the tensioner arm is moved in one direction. The pivot bushing has a tapered surface which is complementary to the pivot surface of the pivot bushing and the coil spring further acts to bias the pivot bushing, and the tensioner arm, up the taper of the pivot shaft pivot surface to compensate for wear of the components and to inhibit off-axis movement of the tensioner arm. Due to the resilient fingers and the engagement thereof by the coil spring, the resulting dampening of the tensioner is more consistent than many prior art tensioners and is substantially maintained over the lifetime of the tensioner.

A unique thermal management system is also disclosed which employs thermal insulating coatings and thermal dispersant coatings to manage the temperature of the tensioner components to enhance their expected operating lifetime.

The above-described embodiments of the invention are intended to be examples of the present invention and alterations and modifications may be effected thereto, by those of skill in the art, without departing from the scope of the invention which is defined solely by the claims appended hereto.

We claim:

1. A tensioner for tensioning an endless flexible drive means, the tensioner comprising:
a pivot shaft having a center bore to receive a mounting means to attach the tensioner to a mounting surface and an outer pivot surface;
a pivot bushing mounted on the outer pivot surface of the pivot shaft;
a tensioner arm receiving the pivot bushing in a bushing bore enabling the tensioner arm to rotate about the pivot shaft, the tensioner arm further including a bearing mount spaced radially from the bushing bore;
a rotatable member mounted to rotate about the bearing mount and having an outer surface configured to engage the flexible member;
a bearing acting between the bearing mount and the rotatable member; and
a coil spring extending from the tensioner arm and configured to be secured to a mounting surface to bias the rotatable member into contact with the flexible drive means, wherein said tensioner arm is molded from an organic resin material.

2. The tensioner of claim 1 wherein the bushing bore and the pivot bushing are configured to present resilient fingers that cooperatively engage the pivot shaft in frictional engagement.

3. The tensioner of claim 2 wherein the coil spring squeezes the resilient fingers when the tensioner arm is pivoted in one direction about the pivot shaft to increase the frictional engagement between the pivot shaft and the pivot bushing to dampen movement of the tensioner arm.

4. The tensioner of claim 3 wherein said coil spring has a first portion having a diameter larger than the resilient fingers, and having a second portion with at least one coil that engages the resilient fingers.

5. The tensioner of claim 4 wherein the pivot bushing interlocks with the tensioner arm.

6. The tensioner of claim 5 wherein said pivot bushing is molded.

7. The tensioner of claim 6 wherein the pivot bushing is over molded onto the tensioner arm.

8. The tensioner of claim 7 wherein the pivot bushing is molded of a different organic resin material than the tensioner arm.

9. The tensioner of claim 8 wherein the outer pivot surface of the pivot shaft is tapered from an end adjacent the first portion of the coil spring to an end adjacent the second portion of the spring and wherein the coil spring also biases the tensioner arm onto the taper.

10. The tensioner of claim 1 wherein the tensioner arm further includes an installation structure to receive a tool to allow the tensioner arm to be rotated against the bias of the coil spring when the flexible drive means is being installed.

11. The tensioner of claim 1 wherein at least some of the portions of the tensioner which abut against the mounting surface have a thermal insulating coating inhibiting heat transfer from the mounting surface to the tensioner.

12. The tensioner of claim 1 wherein the bearing mount of the tensioner arm has a thermal insulating coating inhibiting heat transfer from the bearing to the tensioner arm.

13. The tensioner of claim 1 wherein portions of the tensioner arm have a thermal dispersant coating applied thereto to enhance the transfer of heat from the tensioner arm to the surroundings.

14. The tensioner of claim 1 further comprising a sensor mounted immovably with respect to the mounting surface, and a sensor element on the tensioner arm, the sensor interacting with the sensor element to provide a signal indicating an angular position of the tensioner arm.

15. The tensioner of claim 14 wherein the sensor element is a magnet which is molded into the tensioner arm.

16. The tensioner of claim 1 wherein the tensioner arm is molded from an organic resin material including a conductive material to assist in dissipating static charges from the tensioner arm.

17. The tensioner of claim 1 wherein the tensioner arm includes a conductive coating on at least a portion of its surface, the conductive coating operating to assist in dissipating static charges from the tensioner arm.

18. The tensioner of claim 1 wherein the organic resin material is an engineering plastic.

19. The tensioner of claim 18 wherein the engineering plastic is selected from a group comprising: polyamid, semi-crystalline plastics, polyphtalamide, polyamid and polyimid compounds, polyphenylene sulfide and polyethelene terephtalate.

20. The tensioner of claim 18 wherein the organic resin material is reinforced.

21. The tensioner of claim 18 wherein the organic resin material is reinforced with a material selected from a group comprising: glass fibres, aramid fibres and nanoparticles.

22. The tensioner of claim 18, wherein the organic resin material is mixed with material selected from a group comprising: carbon black, carbon fibers, stainless steel fibers, aluminum flakes and nano carbon.

23. The tensioner of claim 1 wherein the organic resin material is selected from a group comprising an Inherently Conductive Polymer and Inherently Dissipative Polymers.

24. A tensioner for tensioning an endless flexible drive means, the tensioner comprising:
a pivot shaft having a center bore to receive a mounting means to attach the tensioner to a surface and an outer pivot surface;
a rotatable member having an outer surface to engage the flexible member;
a pivot bushing to receive the outer pivot surface of the pivot shaft and having an inner surface complementary in shape to the outer pivot surface of the pivot shaft;
a tensioner arm receiving the pivot bushing in a bushing bore, the tensioner arm further including a bearing mount spaced radially from the pivot shaft and including an installation structure configured to receive a tool to allow the tensioner arm to be rotated to a desired position during installation of the tensioner;
a bearing acting between the bearing mount and the rotatable member to allow the rotatable member to rotate about the bearing mount; and
a spring biasing the rotatable member into contact with the flexible drive means.

25. The tensioner of claim 24 wherein said installation structure comprises at least one pair of diametrically opposed flats surfaces molded on said tensioner arm.

26. A tensioner for tensioning an endless flexible drive means, the tensioner comprising:
a pivot shaft having a center bore to receive a mounting means to attach the tensioner to a mounting surface and an outer pivot surface;
a pivot bushing mounted on the outer pivot surface of the pivot shaft;
a tensioner arm receiving the pivot bushing in a bushing bore enabling the tensioner arm to rotate about the pivot shaft, the tensioner arm further including a bearing mount spaced radially from the bushing bore;
a rotatable member mounted to rotate about the bearing mount and having an outer surface configured to engage the flexible member;
a bearing acting between the bearing mount and the rotatable member; and
a coil spring biasing the rotatable member into contact with the flexible drive means, wherein said tensioner arm is thermally insulated from said mounting surface and said bearing.

27. The tensioner of claim 26 wherein at least some of the portions of the tensioner which engage the mounting surface have a thermal insulating coating inhibiting heat transfer from the mounting surface to the tensioner.

28. The tensioner of claim 27 wherein the bearing mount of the tensioner arm has a thermal insulating coating inhibiting heat transfer from the bearing to the tensioner arm.

29. The tensioner of claim 28 wherein portions of the tensioner arm have a thermal dispersant coating applied thereto to enhance the transfer of heat from the tensioner arm to the surroundings.
